(19) United States
(12) Patent Application Publication
(10) Pub. No.: US 2011/0298795 A1
(43) Pub. Date: Dec. 8, 2011

(54) TRANSFERRING OF 3D VIEWER METADATA

(75) Inventors: Gerardus Wilhelmus Theodorus Van Der Heijden, Eindhoven (NL); Philip Steven Newton, Eindhoven (NL); Christian Benien, Aachen (DE); Felix Gremse, Limbourg (BE)

(73) Assignee: KONINKLIJKE PHILIPS ELECTRONICS N.V., EINDHOVEN (NL)

(21) Appl. No.: 13/201,809

(22) PCT Filed: Feb. 11, 2010
(86) PCT No.: PCT/IB2010/050630

§ 371 Date: Aug. 16, 2011

(30) Foreign Application Priority Data
Feb. 18, 2009 (EP) 09153102.0

(51) Int. Cl. G06T 15/00

(52) U.S. Cl. 345/419

(57) ABSTRACT

A system of processing of three dimensional [3D] image data for display on a 3D display for a viewer is described. 3D display metadata defines spatial display parameters of the 3D display such as depth range supported by the 3D display. Viewer metadata defines spatial viewing parameters of the viewer with respect to the 3D display, such as viewing distance or inter-pupil distance. Source 3D image data arranged for a source spatial viewing configuration is processed to generate target 3D display data for display on the 3D display in a target spatial viewing configuration. First the target spatial configuration is determined in dependence of the 3D display metadata and the viewer metadata. Then, the source 3D image data is converted to the target 3D display data based on differences between the source spatial viewing configuration and the target spatial viewing configuration.

### FIELD OF THE INVENTION

The invention relates to a method of processing of three dimensional [3D] image data for display on a 3D display for a viewer.

The invention further relates to a 3D source device, and a 3D display device, and to a 3D display signal arranged for processing of three dimensional [3D] image data for display on a 3D display for a viewer.

The invention relates to the field processing 3D image data for display on a 3D display, and for transferring, via a high-speed digital interface, e.g. HDMI, such three-dimensional image data, e.g. 3D video, between a source 3D image device and a 3D display device.

### BACKGROUND OF THE INVENTION

Devices for sourcing 2D video data are known, for example video players like DVD players or set top boxes which provide digital video signals. The source device is to be coupled to a display device like a TV set or monitor. Image data is transferred from the source device via a suitable interface, preferably a high-speed digital interface like HDMI. Currently 3D enhanced devices for sourcing three dimensional (3D) image data are being proposed. Similarly devices for displaying 3D image data are being proposed. For transferring the 3D video signals from the source device to the display device new high data rate digital interface standards are being developed, e.g. based on and compatible with the existing HDMI standard.

The document WO2008/038205 describes an example of a 3D image processing for display on a 3D display. The 3D image signal is processed to be combined with graphical data in separate depth ranges of a 3D display.

The document US 2005/0219239 describes a system for processing 3D images. The system generates a 3D image signal from 3D data of objects in a database. The 3D data relates to fully modeled objects, i.e. having a three dimensional structure. The system places a virtual camera in a 3D world based on objects in a computer simulated environment, and generates a 3D signal for a specific viewing configuration. For generating the 3D image signal various parameters of the viewing configuration are used, such as the display size and the viewing distance. An information acquiring unit receives user input, such as the distance between the user and the display.

### SUMMARY OF THE INVENTION

The document WO2008/038205 provides an example of a 3D display device that displays source 3D image data after processing to optimize the viewer experience when combined with other 3D data. The traditional 3D image display system processes the source 3D image data to be displayed in a limited 3D depth range. However, when displaying source 3D image data on a particular 3D display, the viewer experience of the 3D image effect may prove to be insufficient, especially when displaying the 3D image data arranged for a specific viewing configuration on a different display.

It is an object of the invention to provide a system for processing of 3D image data providing a sufficient 3D experience for the viewer when displayed on any particular 3D display device.

For this purpose, according to a first aspect of the invention, the method as described in the opening paragraph, comprises receiving source 3D image data arranged for a source spatial viewing configuration, providing 3D display metadata defining spatial display parameters of the 3D display, providing viewer metadata defining spatial viewing parameters of the viewer with respect to the 3D display, processing the source 3D image data to generate target 3D display data for display on the 3D display in a target spatial viewing configuration, the processing comprising determining the target spatial configuration in dependence of the 3D display metadata and the viewer metadata, and converting the source 3D image data to the target 3D display data based on differences between the source spatial viewing configuration and the target spatial viewing configuration.

For this purpose, according to a further aspect of the invention, the 3D image device for processing of 3D image data for display on a 3D display for a viewer, comprises input means for receiving source 3D image data arranged for a source spatial viewing configuration, display metadata means for providing 3D display metadata defining spatial display parameters of the 3D display, viewer metadata means for providing viewer metadata defining spatial viewing parameters of the viewer with respect to the 3D display, processing means for processing the source 3D image data to generate a 3D display signal for display on the 3D display in a target spatial viewing configuration, the processing means being arranged for determining the target spatial configuration in dependence of the 3D display metadata and the viewer metadata, and converting the source 3D image data to the 3D display signal based on differences between the source spatial viewing configuration and the target spatial viewing configuration.

For this purpose, according to a further aspect of the invention, the 3D source device for providing 3D image data for display on a 3D display for a viewer, comprises input means for receiving source 3D image data arranged for a source spatial viewing configuration, image interface means for interfacing with a 3D display device having the 3D display for transferring a 3D display signal, viewer metadata means for providing viewer metadata defining spatial viewing parameters of the viewer with respect to the 3D display, processing means for generating the 3D display signal for display on the 3D display in a target spatial viewing configuration, the processing means being arranged for including the viewer metadata in the display signal for enabling the 3D display device to process the source 3D image data for display on the 3D display in a target spatial viewing configuration, the processing comprising determining the target spatial configuration in dependence of the 3D display metadata and the viewer metadata, and converting the source 3D image data to the 3D display signal based on differences between the source spatial viewing configuration and the target spatial viewing configuration.

For this purpose, according to a further aspect of the invention, the 3D display device comprises a 3D display for displaying 3D image data, display interface means for interfacing with a source 3D image device for transferring a 3D display signal, which source 3D image device comprises input means for receiving source 3D image data arranged for a source spatial viewing configuration, viewer metadata means for providing viewer metadata defining spatial viewing parameters of the viewer with respect to the 3D display, processing means for generating the 3D display signal for display on the 3D display, the processing means being arranged for transferring, in the display signal via the display interface means to the source 3D image device, the viewer metadata for enabling the source 3D image device to process the source 3D image data for display on the 3D display in a target spatial viewing configuration, the processing comprising determining the target spatial configuration in dependence of the 3D display metadata and the viewer metadata, and converting the source 3D image data to the 3D display signal based on differences between the source spatial viewing configuration and the target spatial viewing configuration.

For this purpose, according to a further aspect of the invention, the 3D display signal for, between a 3D image device and a 3D display, transferring of 3D image data for display on the 3D display for a viewer, comprises viewer metadata for enabling the 3D image device to receive source 3D image data arranged for a source spatial viewing configuration and to process the source 3D image data for display on the 3D display in a target spatial viewing configuration, the viewer metadata being transferred from the 3D display to the 3D image device via a separate data channel or from the 3D image device to the 3D display included in a separate packet, the processing comprising determining the target spatial configuration in dependence of 3D display metadata and the viewer metadata, and converting the source 3D image data to the 3D display signal based on differences between the source spatial viewing configuration and the target spatial viewing configuration.

For this purpose, according to a further aspect of the invention, the 3D image signal for transferring of 3D image data to a 3D image device for display on a 3D display for a viewer, comprises source 3D image data arranged for a source spatial viewing configuration and source image metadata indicative of the source spatial viewing configuration for enabling the 3D image device to process the source 3D image data for display on the 3D display in a target spatial viewing configuration, the processing comprising determining the target spatial configuration in dependence of 3D display metadata and viewer metadata, and converting the source 3D image data to the 3D display signal based on differences between the source spatial viewing configuration and the target spatial viewing configuration.

The measures have the effect that the source 3D image data is processed to provide the intended 3D experience for the viewer, taking into account the actual display metadata, such as screen dimensions, and actual viewer metadata, such as viewing distance and inter-pupil distance of the viewer. In particular, the 3D image data arranged for a source spatial viewing configuration is first received and then re-arranged for a different, target spatial viewing configuration based on the actual viewer metadata of the actual viewing configuration. Advantageously the images that are provided to both eyes of the human viewer are adapted to be in conformance with the actual spatial viewing configuration of the 3D display and the viewer to generate the intended 3D experience.

The invention is also based on the following recognition. The legacy source 3D image data is inherently arranged for a specific spatial viewing configuration, such as a movie for a movie theater. The inventors have seen that such source spatial viewing arrangement may be substantially different from the actual viewing arrangement, which involves a specific 3D display having the specific spatial display parameters, such as screen size, and involves at least one actual viewer, which has actual spatial viewing parameters, e.g. being at an actual viewing distance. Also, the inter-pupil distance of the viewer requires, for optimal 3D experience, that the images produced by the 3D display in both eyes, have a dedicated difference to be perceived as natural 3D image input by the human brain. For example, a 3D object has to be perceived by a child, which has an actual inter-pupil distance smaller than the inter-pupil distance inherently used in the source 3D image data. The inventors have seen that the target spatial viewing configuration is affected by such spatial viewing parameter of the viewer. In particular, this means that for source (non-processed) 3D image content (especially at infinite range) the eyes of children need to diverge, which causes eyestrain or nausea. Additionally, the 3D experience depends on the viewing distance of the people. The solution provided involves providing 3D display metadata and viewer metadata, and subsequently determining the target spatial configuration by calculation based on the 3D display metadata and the viewer metadata. Based on said target spatial viewing configuration the required 3D image data can be generated by converting the source 3D image data based on differences between the source spatial viewing configuration and the target spatial viewing configuration.

In an embodiment of the system the viewer metadata comprises at least one of the following spatial viewing parameters: a viewing distance of the viewer to the 3D display; an inter-pupil distance of the viewer; a viewing angle of the viewer with respect to the plane of the 3D display; a viewing offset of the viewer position with respect to the center of the 3D display.

The effect is that the viewer metadata allows calculating the 3D image data to provide a natural 3D experience for the actual viewer. Advantageously no fatigue or eyestrain occurs for the actual viewer. When there are several viewers, average parameters for the multiple viewers are taken into account such that there is a global optimized viewing experience for all viewers.

In an embodiment of the system the 3D display metadata comprises providing at least one of the following spatial display parameters screen size of the 3D display; depth range supported by the 3D display; user preferred depth range of the 3D display.

The effect is that the display metadata allows calculating the 3D image data to provide a natural 3D experience for the viewer of the actual display. Advantageously no fatigue or eyestrain occurs for the viewer.

It is noted that the viewer metadata, display metadata and/or source image metadata may be available or detected in the source 3D image device and/or in the 3D display device. Also, the processing of the source 3D data for the target spatial viewing configuration may be performed in the source 3D image device or in the 3D display device. Hence providing the meta data at the location of the processing may involve any of the following: detecting, setting, estimating, applying default values, generating, calculating and/or receiving the required meta data via any suitable external interface. In particular, the interface that also transfers the 3D display signal between both devices, or the interface that provides source image data, may be used to transfer the meta data. Thereto the image data interface, which is bi-directional if necessary, may also carry the viewer metadata from the source device to the 3D display device or vice versa. Hence in respective devices as claimed, depending on the system configuration and available interfaces, the metadata means are arranged for cooperating with the interfaces for said receiving, and/or transferring the metadata.

The effect is that various configurations can be made where the viewer metadata and display metadata is provided and transferred to the location of processing. Advantageously practical devices can be configured for the tasks of entering or detecting the viewer metadata, and subsequently processing the 3D source data in dependence thereon.

In an embodiment of the system the viewer metadata means comprise means for setting a child mode for providing, as a spatial viewing parameter an inter-pupil distance representative for a child. The effect is that the target spatial viewing configuration is optimized for children by setting the child mode. Advantageously the user does not have to understand the details of the viewer metadata.

In an embodiment of the system the viewer metadata means comprise viewer detection means for detecting at least one spatial viewing parameter of a viewer present in a viewing area of the 3D display. The effect is that the system autonomously detects relevant parameters of the actual viewer. Advantageously the system may adapt the target spatial viewing configuration when the viewer changes.

Further preferred embodiments of the method, 3D devices and signal according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a system for processing three dimensional (3D) image data,

FIG. 2 shows an example of 3D image data,

FIG. 3 shows a 3D image device and 3D display device metadata interface, and

FIG. 4 shows a table of an AVI-info frame extended with metadata.

In the Figures, elements which correspond to elements already described have the same reference numerals.

### DETAILED DESCRIPTION OF EMBODIMENTS

FIG. 1 shows a system for processing three dimensional (3D) image data, such as video, graphics or other visual information. A 3D image device 10 is coupled to a 3D display device 13 for transferring a 3D display signal 56.

The 3D image device has an input unit 51 for receiving image information. For example the input unit device may include an optical disc unit 58 for retrieving various types of image information from an optical record carrier 54 like a DVD or Blu-Ray disc. Alternatively, the input unit may include a network interface unit 59 for coupling to a network 55, for example the internet or a broadcast network, such device usually being called a set-top box. Image data may be retrieved from a remote media server 57. The 3D image device may also be a satellite receiver, or a media server directly providing the display signals, i.e. any suitable device that outputs a 3D display signal to be directly coupled to a display unit.

The 3D image device has an image processing unit 52 coupled to the input unit 51 for processing the image information for generating a 3D display signal 56 to be transferred via an image interface unit 12 to the display device. The processing unit 52 is arranged for generating the image data included in the 3D display signal 56 for display on the display device 13. The image device is provided with user control elements 15, for controlling display parameters of the image data, such as contrast or color parameter. The user control elements as such are well known, and may include a remote control unit having various buttons and/or cursor control functions to control the various functions of the 3D image device, such as playback and recording functions, and for setting said display parameters, e.g. via a graphical user interface and/or menus.

In an embodiment the 3D image device has a metadata unit 11 for providing metadata. The metadata unit includes a viewer metadata unit 111 for providing viewer metadata defining spatial viewing parameters of the viewer with respect to the 3D display, and a display metadata unit 112 for providing 3D display metadata defining spatial display parameters of the 3D display.

In an embodiment the viewer metadata comprises at least one of the following spatial viewing parameters:

a viewing distance of the viewer to the 3D display;

an inter-pupil distance of the viewer;

a viewing angle of the viewer with respect to the plane of the 3D display;

a viewing offset of the viewer position with respect to the center of the 3D display.

In an embodiment the 3D display metadata comprises at least one of the following spatial display parameters:

screen size of the 3D display;

depth range supported by the 3D display;

a factory recommended depth range, i.e. a range indicated to provide the required quality 3D image, which may be smaller than the maximum supported depth range;

user preferred depth range of the 3D display.

Note that for a depth range also parallax or disparity can be indicated. The above parameters define the geometric arrangement of the 3D display and the viewer, and therefore allow calculating the required images to be generate for the left and right eye of the human viewer. For example, when an object is to be perceived at a required distance of the viewer's eye, the shift of said object in the left and right eye image with respect to the background can be easily calculated.

The 3D image processing unit 52 is arranged for the function of processing source 3D image data arranged for a source spatial viewing configuration to generate target 3D display data for display on the 3D display in a target spatial viewing configuration. The processing includes first determining the target spatial configuration in dependence of the 3D display metadata and the viewer metadata, which metadata is available from the metadata unit 11. Subsequently, the source 3D image data is converted to the target 3D display data based on differences between the source spatial viewing configuration and the target spatial viewing configuration.

Determining a spatial viewing configuration is based on the basic setup of the actual screen in the actual viewing space, which screen has a predefined physical size and further 3D display parameters, and the position and arrangement of the actual viewer audience, e.g. the distance of the display screen to the viewer's eyes. It is noted that in the current approach a viewer is discussed for the case that only a single viewer is present. Obviously, multiple viewers may also be present, and the calculations of spatial viewing configuration and 3D image processing can be adapted to accommodate the best possible 3D experience for said multitude, e.g. using average values, optimal values for a specific viewing area or type of viewer, etc.

The 3D display device 13 is for displaying 3D image data. The device has a display interface unit 14 for receiving the 3D display signal 56 including the 3D image data transferred from the 3D image device 10. The display device is provided with further user control elements 16, for setting display parameters of the display, such as contrast, color or depth parameters. The transferred image data is processed in image processing unit 18 according to the setting commands from the user control elements and generating display control signals for rendering the 3D image data on the 3D display based on the 3D image data. The device has a 3D display 17 receiving the display control signals for displaying the processed image data, for example a dual or lenticular LCD. The display device 13 may be any type of stereoscopic display, also called 3D display, and has a display depth range indicated by arrow 44.

In an embodiment the 3D image device has a metadata unit 19 for providing metadata. The metadata unit includes a viewer metadata unit 191 for providing viewer metadata defining spatial viewing parameters of the viewer with respect to the 3D display, and a display metadata unit 192 for providing 3D display metadata defining spatial display parameters of the 3D display.

The 3D image processing unit 18 is arranged for the function of processing source 3D image data arranged for a source spatial viewing configuration to generate target 3D display data for display on the 3D display in a target spatial viewing configuration. The processing includes first determining the target spatial configuration in dependence of the 3D display metadata and the viewer metadata, which metadata is available from the metadata unit 19. Subsequently, the source 3D image data is converted to the target 3D display data based on differences between the source spatial viewing configuration and the target spatial viewing configuration.

In an embodiment providing the viewer metadata is performed in the 3D image device, e.g. by setting the respective spatial viewing parameters via the user interface 15. Alternatively, providing the viewer metadata may be performed in the 3D display device, e.g. by setting the respective spatial viewing parameters via the user interface 16. Furthermore, said processing of the 3D data to adapt the source spatial viewing configuration to the target spatial viewing configuration may be performed in either one of said devices. Hence in various arrangements of the system said metadata and 3D image processing is provided in either the image device or the 3D display device. Also, both devices may be combined to a single multi function device. Therefore, in embodiments of both devices in said various system arrangements the image interface unit 12 and/or the display interface unit 14 may be arranged to send and/or receive said viewer metadata. Also display metadata may be transferred via the interface 14 from the 3D display device to the interface 12 of the 3D image device.

In said various system arrangements the 3D display signal for transferring of 3D image data includes the viewer metadata. It is noted that the metadata may have a different direction than the 3D image data using a bidirectional interface. The signal providing the viewer metadata, and where appropriate also said display metadata, enables a 3D image device to process source 3D image data arranged for a source spatial viewing configuration for display on the 3D display in a target spatial viewing configuration. The processing corresponds to the processing described above. The 3D display signal may be transferred over a suitable high speed digital video interface such as the well known HDMI interface (e.g. see “High Definition Multimedia Interface Specification Version 1.3a of Nov. 10 2006), extended to define the viewer metadata and/or the display metadata.

FIG. 1 further shows the record carrier 54 as a carrier of the 3D image data. The record carrier is disc-shaped and has a track and a central hole. The track, constituted by a series of physically detectable marks, is arranged in accordance with a spiral or concentric pattern of turns constituting substantially parallel tracks on an information layer. The record carrier may be optically readable, called an optical disc, e.g. a CD, DVD or BD (Blu-ray Disc). The information is represented on the information layer by the optically detectable marks along the track, e.g. pits and lands. The track structure also comprises position information, e.g. headers and addresses, for indication the location of units of information, usually called information blocks. The record carrier 54 carries information representing digitally encoded 3D image data like video in a predefined recording format like the DVD or BD format extended for 3D.

The 3D image data, for example embodied on the record carrier by the marks in the tracks or retrieved via the network 55, provides a 3D image signal for transferring of 3D image data for display on a 3D display for a viewer. In an embodiment the 3D image signal includes source image metadata indicative of the source spatial viewing configuration for which the source image data is arranged. The source image metadata enables a 3D image device to process the source 3D image data for display on the 3D display in a target spatial viewing configuration as described above.

It is noted that, when no specific source image metadata are provided, such data may be set, by the metadata unit, based on a general classification of the source data. For example, 3D movie data may be assumed to have been conceived for viewing in a movie theater of average size, and optimized for the center viewing area, e.g. at a predefined distance of a screen of a predefined size. For example, for TV broadcast source material an average viewers room size and TV size may be assumed. The target spatial viewing configuration, e.g. a mobile phone 3D display, may have substantially different display parameters. Hence the above conversion can be effected using the assumption on the source spatial viewing configuration.

The following section provides an overview of three-dimensional displays and perception of depth by humans. 3D displays differ from 2D displays in the sense that they can provide a more vivid perception of depth. This is achieved because they provide more depth cues then 2D displays which can only show monocular depth cues and cues based on motion.

Monocular (or static) depth cues can be obtained from a static image using a single eye. Painters often use monocular cues to create a sense of depth in their paintings. These cues include relative size, height relative to the horizon, occlusion, perspective, texture gradients, and lighting/shadows. Oculomotor cues are depth cues derived from tension in the muscles of a viewers eyes. The eyes have muscles for rotating the eyes as well as for stretching the eye lens. The stretching and relaxing of the eye lens is called accommodation and is done when focusing on a image. The amount of stretching or relaxing of the lens muscles provides a cue for how far or close an object is. Rotation of the eyes is done such that both eyes focus on the same object, which is called convergence. Finally motion parallax is the effect that objects close to a viewer appear to move faster than objects further away.

Binocular disparity is a depth cue which is derived from the fact that both our eyes see a slightly different image. Monocular depth cues can be and are used in any 2D visual display type. To re-create binocular disparity in a display requires that the display can segment the view for the left- and right eye such that each sees a slightly different image on the display. Displays that can re-create binocular disparity are special displays which we will refer to as 3D or stereoscopic displays. The 3D displays are able to display images along a depth dimension actually perceived by the human eyes, called a 3D display having display depth range in this document. Hence 3D displays provide a different view to the left- and right eye.

3D displays which can provide two different views have been around for a long time. Most of these were based on using glasses to separate the left- and right eye view. Now with the advancement of display technology new displays have entered the market which can provide a stereo view without using glasses. These displays are called auto-stereoscopic displays.

A first approach is based on LCD displays that allow the user to see stereo video without glasses. These are based on either of two techniques, the lenticular screen and the barrier displays. With the lenticular display, the LCD is covered by a sheet of lenticular lenses. These lenses diffract the light from the display such that the left- and right eye receive light from different pixels. This allows two different images one for the left- and one for the right eye view to be displayed.

An alternative to the lenticular screen is the Barrier display, which uses a parallax barrier behind the LCD and in front the backlight to separate the light from pixels in the LCD. The barrier is such that from a set position in front of the screen, the left eye sees different pixels then the right eye. The barrier may also be between the LCD and the human viewer so that pixels in a row of the display alternately are visible by the left and right eye. A problem with the barrier display is loss in brightness and resolution but also a very narrow viewing angle. This makes it less attractive as a living room TV compared to the lenticular screen, which for example has 9 views and multiple viewing zones.

A further approach is still based on using shutter-glasses in combination with high-resolution beamers that can display frames at a high refresh rate (e.g. 120 Hz). The high refresh rate is required because with the shutter glasses method the left and right eye view are alternately displayed. For the viewer wearing the glasses perceives stereo video at 60 Hz. The shutter-glasses method allows for a high quality video and great level of depth.

The auto stereoscopic displays and the shutter glasses method do both suffer from accommodation-convergence mismatch. This does limit the amount of depth and the time that can be comfortable viewed using these devices. There are other display technologies, such as holographic- and volumetric displays, which do not suffer from this problem. It is noted that the current invention may be used for any type of 3D display that has a depth range.

Image data for the 3D displays is assumed to be available as electronic, usually digital, data. The current invention relates to such image data and manipulates the image data in the digital domain. The image data, when transferred from a source, may already contain 3D information, e.g. by using dual cameras, or a dedicated preprocessing system may be involved to (re-)create the 3D information from 2D images. Image data may be static like slides, or may include moving video like movies. Other image data, usually called graphical data, may be available as stored objects or generated on the fly as required by an application. For example user control information like menus, navigation items or text and help annotations may be added to other image data.

There are many different ways in which stereo images may be formatted, called a 3D image format. Some formats are based on using a 2D channel to also carry the stereo information. For example the left and right view can be interlaced or can be placed side by side and above and under. These methods sacrifice resolution to carry the stereo information. Another option is to sacrifice color, this approach is called anaglyphic stereo. Anaglyphic stereo uses spectral multiplexing which is based on displaying two separate, overlaid images in complementary colors. By using glasses with colored filters each eye only sees the image of the same color as of the filter in front of that eye. So for example the right eye only sees the red image and the left eye only the green image.

A different 3D format is based on two views using a 2D image and an additional depth image, a so called depth map, which conveys information about the depth of objects in the 2D image. The format called image+depth is different in that it is a combination of a 2D image with a so called “depth”, or disparity map. This is a gray scale image, whereby the gray scale value of a pixel indicates the amount of disparity (or depth in case of a depth map) for the corresponding pixel in the associated 2D image. The display device uses the disparity, depth or parallax map to calculate the additional views taking the 2D image as input. This may be done in a variety of ways, in the simplest form it is a matter of shifting pixels to the left or right dependent on the disparity value associated to those pixels. The paper entitled “Depth image based rendering, compression and transmission for a new approach on 3D TV” by Christoph Fehn gives an excellent overview of the technology (see http://iphome.hhi.de/fehn/Publications/fehn_EI2004.pdf).

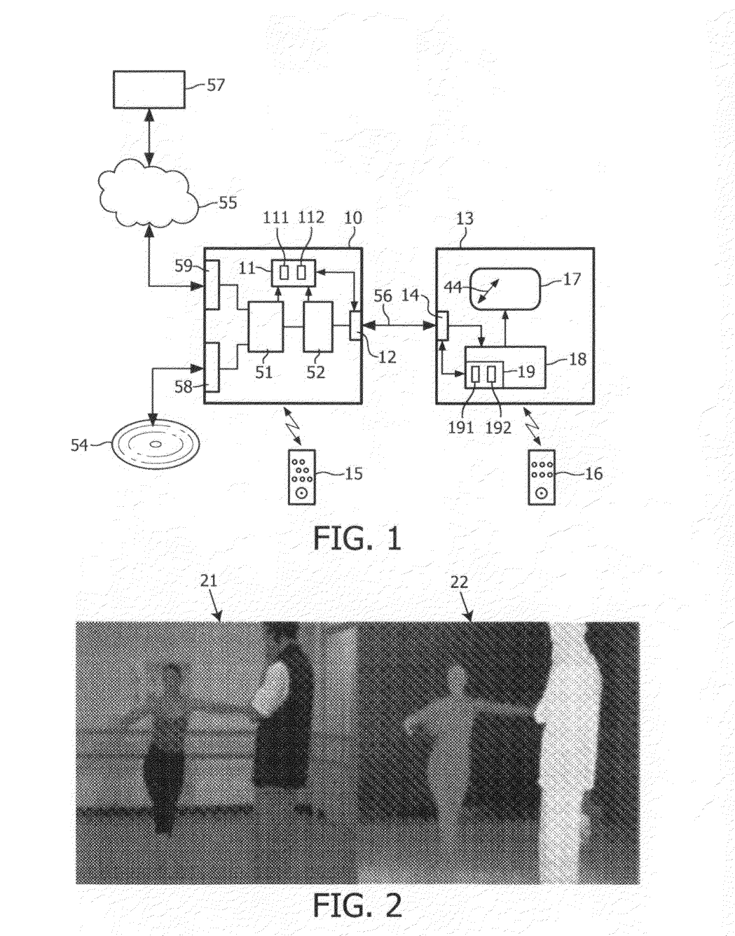

FIG. 2 shows an example of 3D image data. The left part of the image data is a 2D image 21, usually in color, and the right part of the image data is a depth map 22. The 2D image information may be represented in any suitable image format. The depth map information may be an additional data stream having a depth value for each pixel, possibly at a reduced resolution compared to the 2D image. In the depth map grey scale values indicate the depth of the associated pixel in the 2D image. White indicates close to the viewer, and black indicates a large depth far from the viewer. A 3D display can calculate the additional view required for stereo by using the depth value from the depth map and by calculating required pixel transformations. Occlusions may be solved using estimation or hole filling techniques. Additional frames may be included in the data stream, e.g. further added to the image and depth map format, like an occlusion map, a parallax map and/or a transparency map for transparent objects moving in front of a background.

Adding stereo to video also impacts the format of the video when it is sent from a player device, such as a Blu-ray disc player, to a stereo display. In the 2D case only a 2D video stream is sent (decoded picture data). With stereo video this increases as now a second stream must be sent containing the second view (for stereo) or a depth map. This could double the required bitrate on the electrical interface. A different approach is to sacrifice resolution and format the stream such that the second view or the depth map are interlaced or placed side by side with the 2D video.

Multiple devices in the home (DVD/BD/TV) or outside the home (telephone, portable media player) will in the future support display of 3D content on stereoscopic or auto-stereoscopic displays. However, 3D content is mainly developed for a specific screen size. This means that in case content has been recorded for digital cinema it would need to be re-arranged for home display. A solution is to re-arrange the content in the player. Depending on the image data format this requires processing a depth-map, e.g. factor scaling, or shifting Left or Right view for stereo content. Thereto the screen size needs to be known by the player. To do the correct repurposing of the content, not only the screen dimensions are important, but also other factors have to be taken into account. This is for instance the viewer audience, for example the inter-pupil distance of the children is smaller than adults. Incorrect 3D data (especially infinite range) requires the eyes of children to diverge, which causes eyestrain or nausea. Moreover, the 3D experience is dependent on the viewing distance of the people. Data relating to the viewer and his position with respect to the 3D display are called viewer metadata. Also, the display may have a dynamic display area, an optimal depth range, etc. Outside the depth range of the display artifacts may become too high, like for instance crosstalk between the views. This decreases also the viewing comfort of the consumer. The actual 3D display data are called display metadata. The current solution is to store, distribute and make the metadata accessible between the various devices in the home system. For example the metadata may be transferred via the EDID information of the display.

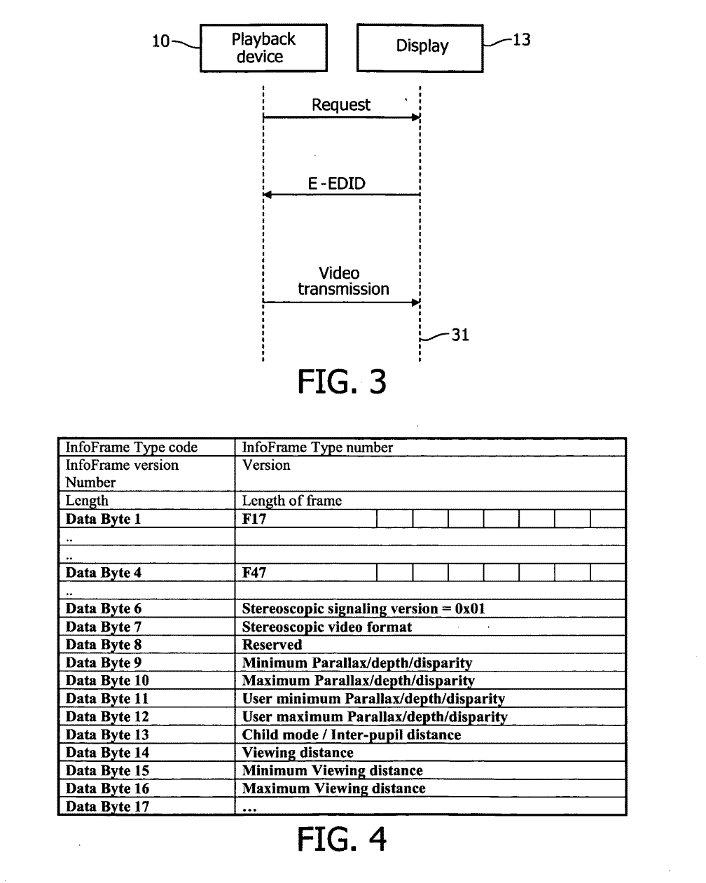

FIG. 3 shows a 3D image device and 3D display device metadata interface. Messages on a bi-directional interface 31 between a 3D image device 10 and 3D display device 13 are shown schematically. The 3D image device 10, e.g. a playback device, reads the capabilities of the display 13 via the interface and adjusts the format and timing parameters of the video to send the highest resolution video, spatially as well as temporal, that the display can handle. In practice a standard is used called EDID. Extended display identification data (EDID) is a data structure provided by a display device to describe its capabilities to an image source, e.g. a graphics card. It enables a modem personal computer to know what kind of monitor is connected. EDID is defined by a standard published by the Video Electronics Standards Association (VESA). Further refer to VESA DisplayPort Standard Version 1, Revision 1a, Jan. 11, 2008 available via http://www.vesa.org/.

The traditional EDID includes manufacturer name, product type, phosphor or filter type, timings supported by the display, display size, luminance data and (for digital displays only) pixel mapping data. The channel for transmitting the EDID from the display to the graphics card is usually the so called I²C bus. The combination of EDID and I²C is called the Display Data Channel version 2, or DDC2. The 2 distinguishes it from VESA's original DDC, which used a different serial format. The EDID is often stored in the monitor in a memory device called a serial PROM (programmable read-only memory) or EEPROM (electrically erasable PROM) that is compatible with the I²C bus.

The playback device sends an E-EDID request to the display over the DDC2 channel. The display responds by sending the E-EDID information. The player determines the best format and starts transmitting over the video channel. In older types of displays the display continuously sends the E-EDID information on the DDC channel. No request is send. To further define the video format in use on the interface a further organization (Consumer Electronics Association; CEA) defined several additional restrictions and extensions to E-EDID to make it more suitable for use with TV type of displays. The HDMI standard (referenced above) in addition to specific E-EDID requirements supports identification codes and related timing information for many different video formats. For example the CEA 861-D standard is adopted in the interface standard HDMI. HDMI defines the physical link and it supports the CEA 861-D and VESA E-EDID standards to handle the higher level signaling. The VESA E-EDID standard allows the display to indicate whether it supports stereoscopic video transmission and in what format. It is to be noted that such information about the capabilities of the display travels backwards to the source device. The known VESA standards do not define any forward 3D information that controls 3D processing in the display.

In an embodiment of the current system the display provides actual viewer metadata and/or actual display metadata. It is to be noted that the actual display metadata differs from the existing display size parameter, such as in E_EDID, in that it defines the actual size of the display area used for displaying the 3D image data, which differs from (e.g. smaller than) the display size previously included in the E-EDID. The E-EDID traditionally provides static information about the device from a PROM. The proposed extension dynamically includes viewer metadata when available at the display device, and other display metadata that is relevant to processing source 3D image data for the target spatial viewing configuration.

In an embodiment viewer metadata and/or display metadata is transferred separately, e.g. as a separate packet in a data stream while identifying the respective metadata type to which it relates. The packet may include further metadata or control data for adjusting the 3D processing. In a practical embodiment the metadata is inserted in packets within the HDMI Data Islands.

An example of including the metadata in Auxiliary Video Information (AVI) as defined in HDMI in an audio video data (AV) stream is as follows. The AVI is carried in the AV-stream from the source device to a digital television (DTV) Monitor as an Info Frame. By exchanging control data it may first be established if both devices support the transmission of said metadata.

FIG. 4 shows a table of an AVI-info frame extended with metadata. The AVI-info frame is defined by the CEA and is adopted by HDMI and other video transmission standards to provide frame signaling on color and chroma sampling, over- and underscan and aspect ratio. Additional information has been added to embody the metadata, as follows. It is to be noted that the metadata may also be transferred via E-EDID or any other suitable transfer protocol in a similar way. The Figure shows communication from source to sink. A similar communication is possible bi-directionally or from Sink to source by any suitable protocol.

In the communication example of FIG. 4, the last bit of data byte 1; F17 and the last bit of data byte 4; F47 are reserved in the standard AVI-info frame. In an embodiment these are used to indicate presence of metadata in the black-bar information. The black bar information is normally contained in Data byte 6 to 13. Bytes 14-27 are normally reserved in HDMI. The syntax of the table is as follows. If F17 is set (=1) then the data byte 9 through to 13 contains 3D metadata parameter information. Default case is when F17 is not set (=0) which means there is no 3D metadata parameter information.

The following information can be added to the AVI or EDID information, as shown by way of example in FIG. 4:

(recommended) minimum parallax (or depth or disparity) supported by the display;

(recommended) maximum parallax (or depth or disparity) supported by the display;

User preferred minimum depth (or parallax or disparity);

User preferred maximum depth (or parallax or disparity);

Child mode (including the inter-pupil distance);

Minimum and maximum viewing distance

It is noted that combined values, and/or separate minimum and maximum or average values of the above parameters may be used. Moreover, some of the information need not be present in the transferred information, but could be provided, set and/or stored in the player or the display respectively, and used by the image processing unit to generate the best 3D content for the specific display. That information can be also transferred between the player towards the display to be able to do the best possible rendering by applying the processing in the display device based on all available viewer information.

The viewer metadata can be retrieved in an automatic or a user controlled way. For instance, the minimum and maximum viewing distance could be inserted by a user via a user menu. The child mode could be controlled by a button on the remote control. In an embodiment, the display has a camera build in. Via image processing, known as such, the device can detect faces of the viewer audience and, based on thereon estimate the viewing distance and possible the inter-pupil distance.

In an embodiment of the display metadata the recommended minimum and/or maximum depth supported by the display is provided by the display manufacturer. The display metadata may be stored in a memory, or retrieved via a network such as the internet.

In summary, the 3D display or the 3D capable player, cooperating to exchange the viewer metadata and display metadata as described above, has all the information to process the 3D image data for optimally rendering the content, and as such give the user the best viewing experience.

It is to be noted that the invention may be implemented in hardware and/or software, using programmable components. A method for implementing the invention has the processing steps corresponding to the processing of 3D image data elucidated with reference to FIG. 1. Although the invention has been mainly explained by embodiments using 3D sourced image data from optical record carriers or the internet to be displayed on home 3D display devices, the invention is also suitable for any image processing environment, like a mobile PDA or mobile phone having a 3D display, a 3D personal computer display interface, or 3D media center coupled to a wireless 3D display device.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and lies in each and every novel feature or combination of features described above.

1. Method of processing of three dimensional [3D] image data for display on a 3D display for a viewer, the method comprising,
receiving source 3D image data arranged for a source spatial viewing configuration,
providing 3D display metadata defining spatial display parameters of the 3D display,
providing viewer metadata defining spatial viewing parameters of the viewer with respect to the 3D display,
processing the source 3D image data to generate target 3D display data for display on the 3D display in a target spatial viewing configuration, the processing comprising
determining the target spatial configuration in dependence of the 3D display metadata and the viewer metadata, and
converting the source 3D image data to the target 3D display data based on differences between the source spatial viewing configuration and the target spatial viewing configuration.

2. Method as claimed in claim 1, wherein providing the viewer metadata comprises providing at least one of the following spatial viewing parameters:
a viewing distance of the viewer to the 3D display;
an inter-pupil distance of the viewer;
a viewing angle of the viewer with respect to the plane of the 3D display;
a viewing offset of the viewer position with respect to the center of the 3D display.

3. Method as claimed in claim 1, wherein providing the 3D display metadata comprises providing at least one of the following spatial display parameters:
screen size of the 3D display;
depth range supported by the 3D display;
factory recommended depth range of the 3D display;
user preferred depth range of the 3D display.

4. 3D image device for processing of three dimensional [3D] image data for display on a 3D display for a viewer, the device comprising
input means (51) for receiving source 3D image data arranged for a source spatial viewing configuration,
display metadata means (112,192) for providing 3D display metadata defining spatial display parameters of the 3D display,
viewer metadata means (111,191) for providing viewer metadata defining spatial viewing parameters of the viewer with respect to the 3D display,
processing means (52,18) for processing the source 3D image data to generate a 3D display signal (56) for display on the 3D display in a target spatial viewing configuration, the processing means (52) being arranged for
determining the target spatial configuration in dependence of the 3D display metadata and the viewer metadata, and
converting the source 3D image data to the 3D display signal based on differences between the source spatial viewing configuration and the target spatial viewing configuration.

5. Device as claimed in claim 4, wherein the device is a source 3D image device and comprises image interface means (12) for outputting the 3D display signal (56) and transferring the viewer metadata.

6. Device as claimed in claim 4, wherein the device is a 3D display device and comprises a 3D display (17) for displaying 3D image data, and display interface means (14) for receiving the 3D display signal (56) and transferring the viewer metadata.

7. 3D source device for providing three dimensional [3D] image data for display on a 3D display for a viewer, the device comprising
input means (51) for receiving source 3D image data arranged for a source spatial viewing configuration,
image interface means (12) for interfacing with a 3D display device having the 3D display for transferring a 3D display signal (56),
viewer metadata means (111) for providing viewer metadata defining spatial viewing parameters of the viewer with respect to the 3D display,
processing means (52) for generating the 3D display signal (56) for display on the 3D display in a target spatial viewing configuration, the processing means being arranged for including the viewer metadata in the display signal for enabling the 3D display device to process the source 3D image data for display on the 3D display in a target spatial viewing configuration, the processing comprising
determining the target spatial configuration in dependence of the 3D display metadata and the viewer metadata, and
converting the source 3D image data to the 3D display signal based on differences between the source spatial viewing configuration and the target spatial viewing configuration.

8. 3D display device comprising
a 3D display (17) for displaying 3D image data,
display interface means (14) for interfacing with a source 3D image device for transferring a 3D display signal (56), which source 3D image device comprises input means (51) for receiving source 3D image data arranged for a source spatial viewing configuration,
viewer metadata means (191) for providing viewer metadata defining spatial viewing parameters of the viewer with respect to the 3D display,
processing means (18) for generating the 3D display signal (56) for display on the 3D display (17), the processing means (18) being arranged for transferring, in the 3D display signal (56) via the display interface means (14) to the source 3D image device, the viewer metadata for enabling the source 3D image device to process the source 3D image data for display on the 3D display in a target spatial viewing configuration, the processing comprising
determining the target spatial configuration in dependence of the 3D display metadata and the viewer metadata, and
converting the source 3D image data to the 3D display signal based on differences between the source spatial viewing configuration and the target spatial viewing configuration.

9. Device as claimed claim 4, wherein the viewer metadata means (111,191) comprise means for setting a child mode for providing, as a spatial viewing parameter, an inter-pupil distance representative for a child.

10. Device as claimed in claim 4, wherein the viewer metadata means (111,191) comprise viewer detection means for detecting at least one spatial viewing parameter of a viewer present in a viewing area of the 3D display.

11. 3D display signal for, between a 3D image device and a 3D display, transferring of three dimensional [3D] image data for display on the 3D display for a viewer, the 3D display signal comprising viewer metadata for enabling the 3D image device to receive source 3D image data arranged for a source spatial viewing configuration and to process the source 3D image data for display on the 3D display in a target spatial viewing configuration, the viewer metadata being transferred from the 3D display to the 3D image device via a separate data channel or from the 3D image device to the 3D display included in a separate packet, the processing comprising
determining the target spatial configuration in dependence of 3D display metadata and the viewer metadata, and
converting the source 3D image data to the 3D display signal based on differences between the source spatial viewing configuration and the target spatial viewing configuration.

12. Signal as claimed in claim 11, wherein the signal is an HDMI signal and the viewer metadata is transferred from the 3D display to the 3D image device via the display data channel (DDC) or from the 3D image device to the 3D display included in a packet in a HDMI data island.

13. 3D image signal for transferring of three dimensional [3D] image data to a 3D image device for display on a 3D display for a viewer, the 3D image signal comprising source 3D image data arranged for a source spatial viewing configuration and source image metadata indicative of the source spatial viewing configuration for enabling the 3D image device to process the source 3D image data for display on the 3D display in a target spatial viewing configuration, the processing comprising
determining the target spatial configuration in dependence of 3D display metadata and viewer metadata, and
converting the source 3D image data to the 3D display signal based on differences between the source spatial viewing configuration and the target spatial viewing configuration.

14. Record carrier comprising physically detectable marks representing the 3D image signal as claimed in claim 13.
